(19) United States
(12) Patent Application Publication
(10) Pub. No.: US 2017/0180152 A1
(43) Pub. Date: Jun. 22, 2017

(54) MULTI-MODE CONTROLLER AREA NETWORK-BLUETOOTH NETWORK BRIDGE

(71) Applicant: BASF Agro B.V., Arnhem (NL)

(72) Inventors: James H. Cink, Wake Forest, NC (US); Charles E. Evanhoe, Dayton, OH (US); Daniel E. Freeman, Springfield, OH (US); Kenneth A. Lauffenburger, Plano, TX (US); Stanford P. Hudson, Dallas, TX (US)

(21) Appl. No.: 15/387,754

(22) Filed: Dec. 22, 2016

Related U.S. Application Data
(60) Provisional application No. 62/270,940, filed on Dec. 22, 2015.

(51) Int. Cl. H04L 12/40; H04L 12/46; G06F 13/42; H04W 4/00

(52) U.S. Cl. CPC H04L 12/40013; H04W 4/008; H04L 12/4625; G06F 13/4282; H04L 2012/40215; H04W 88/06

(57) ABSTRACT

A wireless controller area network (CAN) bus bridge includes a CAN subsystem, a wireless communication module, and a controller coupled to the CAN subsystem and the wireless communication module. The CAN subsystem is configured to be communicatively coupled to a CAN bus to receive a CAN message from the CAN bus. The wireless communication module is operable to wirelessly communicate according to two different versions of a wireless communication protocol. The CAN subsystem is configured to provide the received CAN message to the controller. The controller is programmed to generate a binary message including the received CAN message and to provide the generated binary message to the wireless communication module for transmission from the wireless CAN bus bridge using at least one of the two different versions of the wireless communication protocol.

### CROSS-REFERENCE TO RELATED APPLICATIONS

This patent application relates to and claims priority to U.S. provisional patent application Ser. No. 62/270,940 filed Dec. 22, 2015, which is hereby incorporated by reference in its entirety.

### BACKGROUND OF THE DISCLOSURE

The field of the disclosure relates generally to network bridges, and more particularly to network bridges for connecting a controller area network (CAN) bus and Bluetooth devices.

CAN is a multi-master serial message communication protocol commonly used in vehicles and industrial equipment. It allows microcontrollers and other devices to communicate with each other over a communication bus without a host computer. CAN is a wired communication protocol. Enabling wireless communication with CAN bus typically requires the use of a bridge module that is configured to wirelessly transmit data to and from the CAN bus.

At least one known bridge connected to a CAN bus to wirelessly transmit data to and from the CAN bus using Bluetooth wireless communication. The bridge included a Bluetooth communication module that communicated using the serial port profile (SPP) of Bluetooth version 2.1. The bridge enabled communication between a Bluetooth enabled device and a CAN bus. A pair of the known bridges could be used together to permit wireless bridging of two physically separate CAN buses. This bridge is inoperable with many modern Bluetooth enabled devices, which are not compatible with Bluetooth version 2.1 and/or do not permit the use of SPP. Moreover, the bridge does not perform error checking.

Accordingly, a Bluetooth-CAN bus bridge (BCB) capable of reliably communicating with a broader range of Bluetooth enabled devices is needed. A BCB that is capable of communicating using multiple versions of Bluetooth, such as Bluetooth 2.1 and Bluetooth 4.0 would extend the usefulness of the BCB to many devices. Moreover, a BCB with the capability to simultaneously communicate with different devices using the same or different protocols would be more versatile than known wireless CAN bus bridges.

### BRIEF DESCRIPTION OF THE DISCLOSURE

In one aspect, a wireless controller area network (CAN) bus bridge includes a CAN subsystem, a wireless communication module, and a controller coupled to the CAN subsystem and the wireless communication module. The CAN subsystem is configured to be communicatively coupled to a CAN bus to receive a CAN message from the CAN bus. The wireless communication module is operable to wirelessly communicate according to two different versions of a wireless communication protocol. The CAN subsystem is configured to provide the received CAN message to the controller. The controller is programmed to generate a binary message including the received CAN message and to provide the generated binary message to the wireless communication module for transmission from the wireless CAN bus bridge using at least one of the two different versions of the wireless communication protocol.

In another aspect, a Bluetooth to controller area network bridge (BCB) device includes a controller area network (CAN) subsystem, a Bluetooth module, and a controller coupled to the CAN subsystem and the Bluetooth module. The CAN subsystem is configured to communicate with a CAN bus when attached to the CAN bus. The Bluetooth module is operable to wirelessly communicate according to a first version of the Bluetooth communication protocol and a second version of the Bluetooth communication protocol. The first version and the second version are different versions of the Bluetooth communication protocol. The controller is programmed to provide, through the Bluetooth module, wireless communication between the CAN bus and a first remote device using the first version of the Bluetooth communication protocol.

In still another aspect, a method of communicating with a controller area network (CAN) bus using a bridge device includes receiving, by a CAN subsystem of the bridge device, a first CAN message from a first CAN bus. A controller of the bridge device receives the first CAN message from the CAN subsystem, and generates a first binary message including the first CAN message. A Bluetooth module of the bridge device is operable to communicate according to a first version of the Bluetooth communication protocol and a second version of the Bluetooth protocol. The Bluetooth module transmits the first binary message to a first device using the first version of the Bluetooth communication protocol.

### BRIEF DESCRIPTION OF THE DRAWINGS

FIG. 1 is a schematic block diagram of an example Bluetooth-CAN bus bridge (BCB) device coupled to a controller area network (CAN) bus.

FIG. 2 is a diagram of a configuration for use of the BCB device of FIG. 1 to wirelessly connect the CAN bus to a remote device.

FIG. 3 is a diagram of a configuration for use of the BCB device of FIG. 1 to wirelessly connect the CAN bus to a remote CAN bus.

FIG. 4 is a diagram of a configuration for use of the BCB device of FIG. 1 to wirelessly connect the CAN bus to a remote CAN bus and a remote device.

FIG. 5 is a schematic illustration of an exemplary embodiment of an apparatus for applying a soil treatment beneath the surface of the ground in which the apparatus includes a base unit, a handheld portable high pressure application tool, and a handheld portable low pressure application tool.

FIG. 6 is a front view schematic illustration of the high pressure application tool of FIG. 5.

FIG. 7 is a schematic illustration of a control system and communication capabilities of the apparatus of FIG. 5.

FIG. 8 is a schematic diagram of an example computing device suitable for use in the BCB device of FIG. 1 and the apparatus of FIG. 5.

### DETAILED DESCRIPTION OF THE DISCLOSURE

A Bluetooth-CAN bus bridge (BCB) device is described in detail below. The BCB device can be used as a bridge between a Bluetooth network and a CAN network. The BCB device is connected to a CAN network and wirelessly connects/establishes a Bluetooth network. It allows a device with Bluetooth capability, such as a cell phone, tablet, or computer, to monitor and control devices that are interconnected on a CAN network. In addition to CAN data transport, the Bluetooth interface also serves as an administration interface for device configuration.

The BCB device can also operate to bridge multiple separate CAN networks together wirelessly using Bluetooth. In this configuration, each CAN network is connected to one BCB device. A Bluetooth network is established between the two BCB devices and CAN data can be transported between the two CAN networks over the Bluetooth network.

The example BCB device supports Bluetooth v4.0, allowing it to operate with legacy Bluetooth (e.g., Bluetooth v2.x) and Bluetooth Low Energy (BLE) communication. The BCB uses legacy Bluetooth with Bluetooth's Serial Port Profile (SPP) to transport CAN protocol communications when bridging two CAN networks. The BCB can communicate with a Bluetooth enabled device using BLE's Serial Port Service (SP) or Bluetooth classic's SPP.

The ASCII serial data of CAN messages on the CAN bus is encapsulated by the BCB device in a binary message according to a binary command-response protocol for transmission over Bluetooth. The protocol encapsulates the data along with a cyclic redundancy code (CRC) to permit error checking. Moreover, the BCB device provides a selectable CAN bus termination allowing the BCB device to be connected to a CAN bus anywhere along the bus and provide a CAN bus termination if desired or needed for the particular CAN bus configuration.

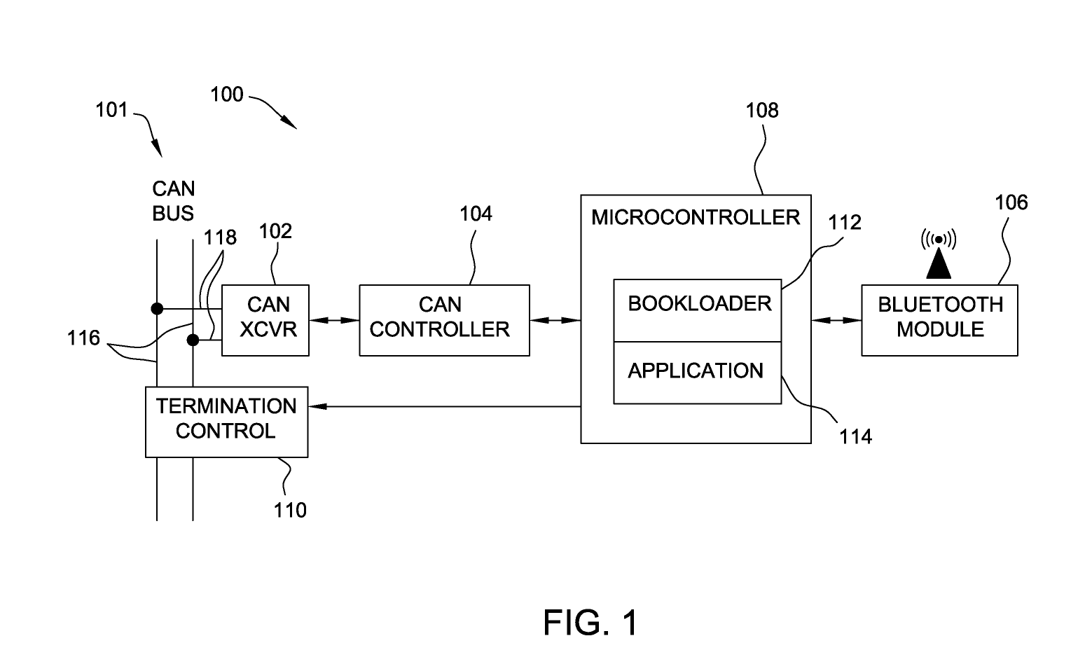

Referring to the drawings, FIG. 1 is a schematic block diagram of an example BCB device 100 coupled to a CAN bus 101. The BCB device 100 includes a CAN transceiver 102, a CAN controller 104, a Bluetooth module 106, a BCB controller 108, and a selectable termination 110.

The CAN transceiver 102 and the CAN controller 104 cooperatively receive messages from the CAN bus and provide those messages to the controller 108. The CAN transceiver 102 and the CAN controller 104 also place messages from the BCB controller on the CAN bus. The CAN transceiver 102 and the CAN controller 104 are sometimes collectively referred to herein as a CAN subsystem. Although shown as separate components in FIG. 1, the CAN transceiver 102 and the CAN controller 104 may be a single component.

The CAN transceiver 102 supports ISO-11898-5 standard physical layer with electrostatic discharge (ESD) protection on the CAN High (CANH) and CAN Low (CANL) signals. In a suitable embodiment, the CAN transceiver 102 is a Microchip CAN transceiver, part number MCP2562T-E/SN, available from Microchip Technology Inc. of Chandler, Ariz., USA. In other suitable embodiments, the CAN transceiver 102 is any other suitable CAN controller capable of performing as described herein.

The CAN controller 104 supports both standard and extended ID modes and has the ability to filter messages based on address or message content. The CAN controller 104 supports both transmit and receive buffering of messages. It implements CAN V2.0B or higher standard with a 250 kbps minimum bitrate. In a suitable embodiment, the CAN controller 104 is a Microchip CAN controller with SPI interface, part number MCP2515-I/ML, available from Microchip Technology Inc. of Chandler, Ariz., USA. In other suitable embodiments, the CAN controller 104 is any other suitable CAN controller capable of performing as described herein.

The Bluetooth module 106 receives messages from BCB controller 108, including encapsulated CAN messages, and transmits them from the BCB device 100 using Bluetooth protocols. The Bluetooth module 106 also receive Bluetooth communication from a device (not shown in FIG. 1) connected via Bluetooth to the BCB device 100 and provides the received messages to the BCB controller 108. The Bluetooth module 106 is a dual-mode module capable of handling legacy Bluetooth (e.g., Bluetooth v2.x) and Bluetooth v4.x with Bluetooth low-energy (BLE). The Bluetooth module 106 includes an ASCII AT command set and is capable of operating in simultaneous dual-mode (e.g., a legacy Bluetooth connection can exist simultaneously with a BLE connection). The Bluetooth module 106 will provide the Bluetooth address in response to a query via the AT command set and will respond to appropriate queries (both via signal and via the AT command) with a response indicating whether or not the Bluetooth module 106 has an active connection and whether or not the Bluetooth module 106 has completed its boot-up process. The Bluetooth module 106 maintains configuration when powered off, and the supports the ability to reset the configuration to factory defaults. In a suitable embodiment, the Bluetooth module is a Dual-Mode Bluetooth module, part number OBS421X-24, available from U-Blox Holding AG of Thalwil, Switzerland. In other suitable embodiments, the Bluetooth module 106 is any other suitable CAN controller capable of performing as described herein.

The BCB controller 108 is responsible for controlling the BCB device 100 and managing communication with the CAN controller 104 and the Bluetooth module 106. The BCB controller 108 includes two separate executable images, a bootloader 112 and an application 114. The bootloader 112 is firmware that is responsible for ensuring the integrity of the application 114, handling updates to the application 114 when required, and invoking the application 114 upon boot-up of the BCB device 100. The application 114 is firmware with two modes of operation: normal and configuration. The normal mode of the application 114 handles normal the normal operation of the BCB device 100 as described herein. The normal mode handles processing of bridge commands, but does not support commands that can alter or retrieve the configuration of the BCB controller 108.

In the example embodiment, the BCB controller 108 is a microcontroller. The microcontroller operates at a minimum frequency of 16 MHz and has a minimum of 16 KB flash and 512 B RAM. The microcontroller has at least one UART (receive/transmit signals), one SPI peripheral (DI/DO/CLK/CS signals), and seventeen general-purpose I/O pins. The flash memory for the microcontroller is in-system programmable to facilitate firmware updates. In a suitable embodiment, BCB controller is a Texas Instruments 16-bit Microcontroller, part number MSP430G2553IRHB32R, available from Texas Instruments Incorporates of Dallas, Tex., USA. In other suitable embodiments, the BCB controller 108 is any other suitable digital, analog, or analog and digital controller operable as described herein.

The selectable termination 110 is a controlled, switchable CAN bus termination. The BCB controller 108 can enable or disable the selectable termination 110. Enabling the selectable termination 110 connects the resistance of the selectable termination 110 across the signal wires 116 of the CAN bus in parallel with the outputs 118 of the CAN transceiver 102, and disabling the selectable termination 110 removes the resistance of the selectable termination 110 from the signal wires 116 of the CAN bus. Thus, for example, the BCB device 100 can provide the termination at the one end of a high-speed CAN bus, can omit the termination if the BCB device 100 is positioned in the middle of a high-speed CAN bus that is already terminated at its ends, can provide the needed termination when used as a CAN device on a low-speed CAN bus, and the like. The enablement or disablement of the selectable termination 110 is accomplished by configuration in the BCB controller 108.

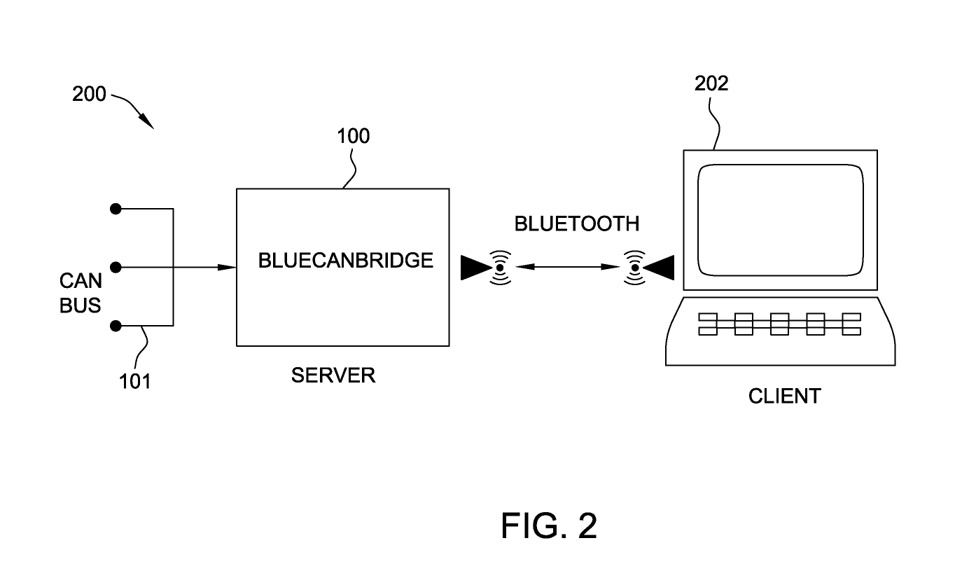

As described above, the BCB device 100 can be used as a bridge in many different configurations. FIGS. 2-4 are diagrams of three example configurations in which the BCB device 100 can be used.

FIG. 2 is a diagram of a first configuration 200 for use of the BCB device 100. In this configuration, the BCB device 100 is used to wirelessly connect the CAN bus 101 to a remote device 202 to allow the remote device 202 to interact with the BCB device 100 and the Can bus data. Although the remote device 202 is illustrated as a computer, the remote computing device may be any other suitable Bluetooth enabled remote device, such as a cellular phone, tablet, PDA, and the like. In the configuration 200, the BCB device 100 operates in server mode and the remote device 202 is a client of the BCB device 100. The BCB device 100 can communicate with remote device 202 using legacy Bluetooth or a modern BLE connection depending on the capabilities of the remote computing device. Generally, a BLE connection using the SP service is preferred for energy efficiency and security. However, if the remote device 202 is not capable of a BLE connection, legacy Bluetooth's SPP may be used.

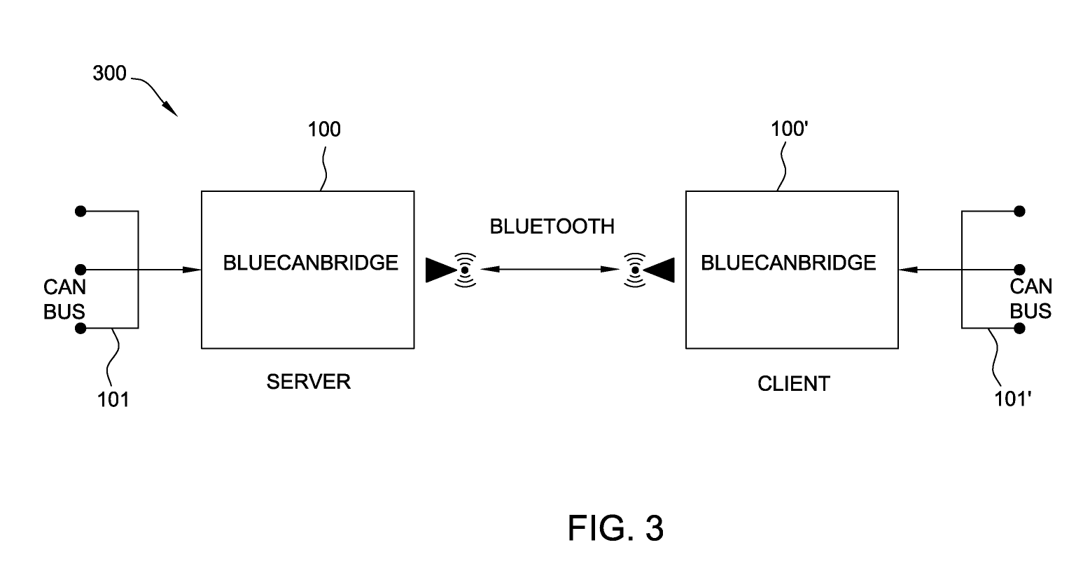

FIG. 3 is a diagram of a second configuration 300 for use of the BCB device 100. In this configuration, BCB device 100 is used with a second BCB device 100′ to wirelessly connect the CAN bus 101 to a remote CAN bus 101′. The BCB device 100′ is identical to BCB device 100. The configuration 300 allows CAN bus communication to pass between the two CAN buses 101 and 101′. In the configuration 300, BCB device 100 operates in server mode and the second BCB device 100′ is a client of the BCB device 100. The connection between BCB devices 100 and 100′ is a BLE connection. Alternatively, the connection between BCB devices 100 and 100′ may be a legacy Bluetooth connection using SPP. The CAN devices coupled to the CAN bus 101 and the CAN device coupled to the CAN bus 101′ (not shown) are ignorant of the existence of the BCB devices 100 and 100′. In operation, when a message on CAN bus 101 is received by the BCB device 100 through the CAN transceiver 102 and the CAN controller 104 (both shown in FIG. 1), the microcontroller 108 (also shown in FIG. 1) encapsulates the received message data in a binary message. The binary message is transmitted over the Bluetooth connection to the BCB device 100′. The microcontroller 108 of the BCB device 100′ extracts the encapsulated message data from the binary message, formats the data for transmission on the CAN bus 101′, and outputs the CAN formatted message data to the CAN controller 104. The CAN controller 104 and the CAN transceiver 102 place the message data on the CAN bus 101′. The BCB device 100′ performs the same operation as the BCB device 100 to pass messages from the CAN bus 101′ to the CAN bus 100′.

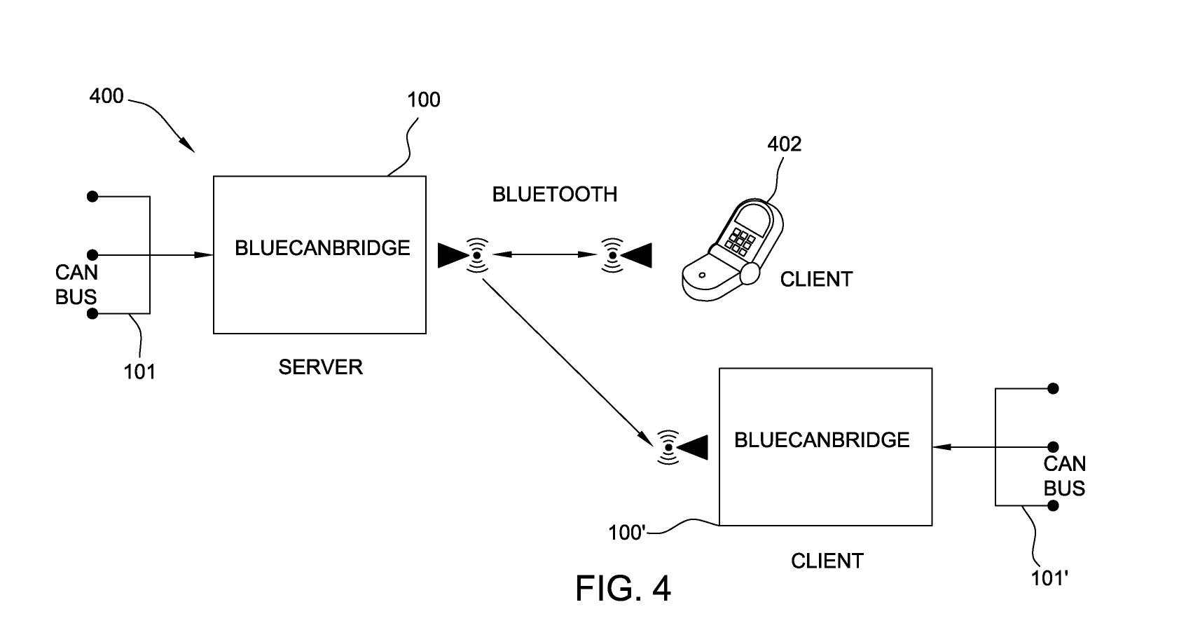

FIG. 4 is a diagram of a third configuration 400 that combines the first and third configurations shown in FIGS. 2 and 3. In this configuration 400, the BCB device 100 is used to wirelessly connect the CAN bus 101 to the remote device 402 to allow the remote device 402 to interact with the BCB device 100 and the CAN bus data. Although the remote device 402 is illustrated as a cell phone, the remote computing device may be any other suitable Bluetooth enabled remote device. In the configuration 400, the BCB device 100 is simultaneously used with the second BCB device 100′ to wirelessly connect the CAN bus 101 to the remote CAN bus 101′. The configuration 400 allows CAN bus communication to pass between the two CAN buses 101 and 101′. In the configuration 300, BCB device 100 operates in server mode and the second BCB device 100′ and the remote device 402 are clients of the BCB device 100. The connection between BCB devices 100 and 100′ is a BLE connection, while the connection with the remote device 402 is either a BLE or legacy Bluetooth connection depending on the capabilities of the remote device 402. As discussed above with regard to the first configuration 200, a BLE connection is preferred if it is within the capabilities of the remote device 402. In other embodiments, the connection between BCB devices 100 and 100′ is a legacy Bluetooth connection using SPP.

The BCB 100 utilizes a binary command-response messaging protocol comprised of a header/signature byte (<hdr>), a length byte (<len>), command byte (<cmd>), one or more data bytes, and a 16-bit CRC. The CRC is computed over the bytes starting with the header (<hdr>) up until the two CRC bytes. Thus, the BCB device's messages take the general form of:

<hdr><len><cmd> . . . <crc0><crc1> (1)

Table 1 identifies the fields of the messages used by the BCB device 100, while Table 2 provides a summary of commands and responses utilized in the messaging protocol. Not all commands have a response (such as the Bridge and Keep Alive commands).

TABLE 1

| Field | Description |
|---|---|
| <hdr> | Header (signature) byte 0xA5 |
| <len> | Length of message (including CRC) |
| <cmd> | Command (see summary below). If MSb is |
| | set, then message is a response to a |
| | command. |
| . . . | One or more message data bytes |
| <crc0> | LSB of 16-bit CRC |
| <crc1> | MSB of 16-bit CRC |

TABLE 2

| <cmd> | Type | Format |
|---|---|---|
| 0x00 | Bridge | <hdr><len><cmd><flags><dlc><id0><id1> |
| | | <id2><id3><d0><d1><d2><d3><d4><d5> |
| | | <d6><d7><crc0><crc1> |
| 0x01 | Get Configuration | <hdr><len><cmd><crc0><crc1> |
| 0x81 | Get Configuration | <hdr><len><cmd+rsp><flags><a0><a1><a2> |
| | response | <a3><a4><a5><crc0><crc1> |
| 0x02 | Set Configuration | <hdr><len><cmd><flags><a0><a1><a2><a3> |
| | | <a4><a5><crc0><crc1> |
| 0x82 | Set Configuration response | <hdr><len><cmd+rsp><crc0><crc1> |
| 0x03 | Get Version | <hdr><len><cmd><crc0><crc1> |
| 0x83 | Get Version response | <hdr><len><cmd+rsp> |
| 0x04 | Echo | <hdr><len><cmd><crc0><crc1> |
| 0x84 | Echo response | <hdr><len><cmd+rsp><crc0><crc1> |
| 0x05 | Write Block | <hdr><len><cmd> |
| 0x85 | Write Block response | <hdr><len><cmd+rsp><crc0><crc1> |
| 0x06 | Keep Alive | <hdr><len><cmd><crc0><crc1> |
| 0x8F | Error response | <hdr><len><cmd><crc0><crc1> |

A 16-bit CRC (CRC-16-CCITT polynomial 0x1021, initial value of 0xFFFF) is used to ensure integrity of the messaging protocol. For the protocol, the CRC is computed over the bytes starting with the header/signature (<hdr>) up until the two CRC bytes. The C− listing of the CRC-16 algorithm is shown below:

```
void UpdateCrc(u8_tx, u16_t *crc16)
{
  u16_t next = (u8_t)(*crc16 >> 8) | (*crc16 << 8);
  next \hat{ }= x;
  next \hat{ }= (u8_t)(next & 0xFF) >> 4;
  next \hat{ }= next << 12;
  next \hat{ }= (next & 0xFF) << 5;
  *crc16 = next;
}
```

The application 114 and bootloader 112 both support one or more of the protocol commands. The application 114 has two modes of operation: Normal and Configuration. Normal mode handles normal processing of BCB device 100 commands, but does not support commands that can alter or retrieve the configuration. The Write Block command is not applicable to the application 114 and is only supported by the bootloader 112.

While executing the application 114, the BCB device 100 will be in either Normal (default) or Configuration mode. The user manually puts the BCB device into the configuration mode. To exit configuration mode, the BCB device 100 must be power-cycled. Table 3 lists the supported modes and applicable firmware for each command.

TABLE 3

| | Firmware | | |
|---|---|---|---|
| | Application | Bootloader | |
| Command | 114 | 112 | Application Mode |
| Bridge | • | | Both |
| Set Configuration | • | | Configuration |
| Get Configuration | • | | Configuration |
| Get Version | • | • | Configuration |
| Echo | • | • | Configuration |
| Write Block | | • | n/a |
| Keep Alive | • | | Both |

Each of the available commands will be explained below, the syntax for messages invoking the commands, and some examples will be described below.

### Write Block Command

The Write Block command writes 16 bytes of data to a specified 16-bit address in flash memory. This command is only supported by the bootloader 112. Table 4, below, describes the syntax for a write block command message, the response syntax, and an example.

TABLE 4

| | |
|---|---|
| Syntax | <hdr><len><cmd><a0><a1> |
| | <d0><d1><d2><d3><d4><d5><d6><d7> |
| | <d8><d9><d10><d11><d12><d13><d14><d15> |
| | <crc0><crc1> |
| | <hdr> - set to A5 hex |
| | <len> - set to 15 hex (21 decimal) |
| | <cmd> - set to 05 hex |
| | <a0> - LSB of 16-bit address 0000-EFFF |
| | <a1> - MSB of 16-bit address 0000-EFFF |
| | <d0> . . . <d15> - data bytes |
| | <crc0> - LSB of 16-bit CRC |
| | <crc1> - MSB of 16-bit CRC |
| Response | <hdr><len><cmd+rsp><crc0><crc1> |
| | <hdr> - set to A5 hex |
| | <len> - set to 03 hex |
| | <cmd+rsp> - set to 85 hex (rsp = 0x80, MSb set to 1) |
| | <crc0> - LSB of 16-bit CRC |
| | <crc1> - MSB of 16-bit CRC |
| Example | Command: |
| | A5150520C01933F302E4E20020FC008E23285FDDEC76FA |
| | Writes data bytes 19, 33, F3, 02, E4, E2, 00, 20, FC, 00, 8E, |
| | 23, 28, 5F, DD, and EC to address 0xC020 with a CRC of |
| | 0XFA76 |
| | Response: |
| | A58503A206 |

### Keep Alive Command

The Keep Alive command is used by the BCB 100 to maintain the high-level connection. It is only applicable to the application 114. The syntax for a keep alive command message, the response syntax, and an example are described in Table 5 below.

TABLE 5

| | |
|---|---|
| Syntax | <hdr><len><cmd><crc0><crc1> |
| | <hdr> - set to A5 hex |
| | <len> - set to 03 hex |
| | <cmd> - set to 06 hex |
| | <crc0> - LSB of 16-bit CRC |
| | <crc1> - MSB of 16-bit CRC |
| Response | None |
| Example | Command: |
| | A5030639E7 |

### Echo Command

The Echo command is used to ping the BCB device 100. The syntax for an echo command message, the response syntax, and an example are described in Table 6 below.

TABLE 6

| | |
|---|---|
| Syntax | <hdr><len><cmd><crc0><crc1> |
| | <hdr> - set to A5 hex |
| | <len> - set to 03 hex |
| | <cmd> - set to 04 hex |
| | <crc0> - LSB of 16-bit CRC |
| | <crc1> - MSB of 16-bit CRC |
| Response | <hdr><len><cmd+rsp><crc0><crc1> |
| | <hdr> - set to A5 hex |
| | <len> - set to 03 hex |
| | <cmd+rsp> - set to 84 hex (rsp = 0x80, MSb set to 1) |
| | <crc0> - LSB of 16-bit CRC |
| | <crc1> - MSB of 16-bit CRC |
| Example | Command: |
| | A503047BC7 |
| | Response: |
| | A5038456F3 |

### Bridge Command

The Bridge command contains an encapsulated CAN message to be sent over the CAN bus. Bluetooth CAN bridge messages sent by the device contain messages received over the CAN bus. No response is sent back for the Bridge command. The syntax for a bridge command message and an example are described in Table 7 below. Table 8 provides description of some of parameters used in the bridge messages.

TABLE 7

| | |
|---|---|
| Syntax | <hdr><len><cmd><flags><dlc> |
| | <id0><id1><id2><id3><d0><d1><d2><d3><d4> |
| | <d5><d6><d7><crc0><crc1> |
| | <hdr> - set to A5 hex |
| | <len> - set to 11 hex (17 decimal) |
| | <cmd> - set to 00 hex |
| | <flags> - flags field |
| | <dlc> - number of data bytes |
| | <id0> . . . <id3> - ID |
| | <d0> . . . <d7> - data bytes |
| | <crc0> - LSB of 16-bit CRC |
| | <crc1> - MSB of 16-bit CRC |
| Response | None |
| | Encapsulated CAN message will be transmitted |
| | over the CAN bus |
| Example | A51100010803450000128F2A8200000000C1AF |

| | |
|---|---|
| Flags: | 01 (extended ID) |
| ID: | 00004503 |
| Number of data bytes: | 4 |
| Data: | 0x12, 0x8F, 0x2A, 0x82 |
| CRC: | 0xAFC1 |

TABLE 8

| Parameters | Description |
|---|---|
| <flags> | 00 = standard ID, 01 = extended ID. |
| <id3>, <id2>, | 32-bit ID (extended or standard). <eid3> is |
| <id1>, <id0 | the MSB, <eid0> is the LSB. |
| <dlc> | Number of data bytes (00 to 08). |
| <d0> . . . <d7> | Data bytes. Eight (8) byte values must always |
| | be specified, regardless of the value of <dlc>. |

### Get Configuration Command

The Get Configuration command gets (reads) back configuration information from the BCB device 100. The syntax for a get configuration command message, the response syntax, and an example are described in Table 9 below.

TABLE 9

| Syntax | <hdr><len><cmd><crc0><crc1> | | | |
|---|---|---|---|---|
| | <hdr> - set to A5 hex | | | |
| | <len> - set to 03 hex | | | |
| | <cmd> - set to 01 hex | | | |
| | <crc0> - LSB of 16-bit CRC | | | |
| | <crc1> - MSB of 16-bit CRC | | | |
| Response | <hdr><len><cmd+rsp><flags><a0><a1><a2><a3><a4><a5> | | | |
| | <crc0><crc1> | | | |
| | <hdr> - set to A5 hex | | | |
| | <len> - set to 0A hex (10 decimal) | | | |
| | <cmd+rsp> - set to 81 hex (rsp=0x80, MSb set to 1) | | | |
| | <flags> - configuration flags (see below) | | | |
| | <a0>... <a5> - 6-byte Bluetooth server address (see below) | | | |
| | <crc0> - LSB of 16-bit CRC | | | |
| | <crc1> - MSB of 16-bit CRC | | | |
| | <flags>: | | | |
| | 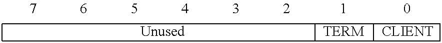 | | | |
| | Unused | Bits 7-2 | Unused | |
| | TERM | Bit 1 | CAN bus termination enable | |
| | | | 0 | Disabled |
| | | | 1 | Enabled |
| | CLIENT | Bit 0 | 0 | Client mode |
| | | | 2 | Server mode |

| | |
|---|---|
| | <a0>... <a5>: 6-byte Bluetooth server address. The server Bluetooth |
| | address is the address the BCB device 100 should attempt to connect to |
| | when configured as a client. |
| Example | Command: |
| | A50301DE97 |
| | Response: |
| | A50A8101AB1323F3120093DAD |
| | CAN bus termination enabled, device is a client |
| | Server address 00-12-F3-23-13-AB |

### Set Configuration Command

The Set Configuration command sets (writes) configuration information to the BCB device 100, such as the wireless mode (client or server), the CAN bus termination setting, as well as the server address if configured as a client. The syntax for a set configuration command message, the response syntax, and an example are described in Table 10 below.

TABLE 10

| Syntax | <hdr><len><cmd><flags><a0><a1><a2><a3><a4><a5><crc0><crc1> | | | |
|---|---|---|---|---|
| | <hdr> - set to A5 hex | | | |
| | <len> - set to 0A hex (10 decimal) | | | |
| | <cmd> - set to 02 hex | | | |
| | <flags> - configuration flags (see below) | | | |
| | <a0>... <a5> - 6-byte Bluetooth server address (see below) | | | |
| | <crc0> - LSB of 16-bit CRC | | | |
| | <crc1> - MSB of 16-bit CRC | | | |
| | <flags>: | | | |
| | 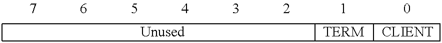 | | | |
| | Unused | Bits 7-2 | Unused | |
| | TERM | Bit 1 | CAN bus termination enable | |
| | | | 0 | Disabled |
| | | | 1 | Enabled |
| | CLIENT | Bit 0 | 0 | Client mode |
| | | | 2 | Server mode |

| | |
|---|---|
| | <a0>... <a5>: 6-byte Bluetooth server address. The server Bluetooth |
| | address is the address the BCB device 100 should attempt to connect to when |
| | configured as a client. |
| Response | <hdr><len><cmd+rsp><crc0><crc1> |
| | <hdr> - set to A5 hex |
| | <len> - set to 03 hex |
| | <cmd+rsp> - set to 82 hex (rsp=0x80, MSb set to 1) |
| | <crc0> - LSB of 16-bit CRC |
| | <crc1> - MSB of 16-bit CRC |
| Example | Command: |
| | A50A0201AB1323F312009AA8 |
| | CAN bus termination enabled, device is a client |
| | Server address 00-12-F3-23-13-AB |

### Get Version Command

The Get Version command retrieves firmware and hardware version information for the BCB 100. The syntax for a get version command message, the response syntax, and an example are described in Table 11 below.

TABLE 11

| | |
|---|---|
| Syntax | <hdr><len><cmd><crc0><crc1> |
| | <hdr> - set to A5 hex |
| | <len> - set to 03 hex |
| | <cmd> - set to 03 hex |
| | <crc0> - LSB of 16-bit CRC |
| | <crc1> - MSB of 16-bit CRC |
| Response | <hdr><len><cmd+rsp><fwver><hwver><crc0><crc1> |
| | <hdr> - set to A5 hex |
| | <len> - set to 05 hex |
| | <cmd+rsp> - set to 83 hex (rsp = 0x80, MSb set to 1) |
| | <fwver> - firmware version byte |
| | <hwver> - hardware/board version byte |
| | <crc0> - LSB of 16-bit CRC |
| | <crc1> - MSB of 16-bit CRC |
| Example | Command: |
| | A503039CB7 |
| | Response: |
| | A505830501B836 |
| | Firmware version 05 |
| | Hardware/board version 01 |

The BCB device 100 may be used to provide Bluetooth communication capabilities to any CAN bus. For example, the BCB device 100 may be coupled to a CAN bus in a vehicle to wirelessly connect the vehicle CAN bus to another CAN bus and/or to a Bluetooth enabled device. Similarly, the BCB device 100 may be used to provide wireless communication capabilities to a CAN bus in industrial equipment. Another suitable application for the BCB device 100 is to provide wireless communication between two CAN buses of a soil treatment system and to permit wireless connection of the soil treatment system to a Bluetooth enabled remote device.

In one non-limiting example, the BCB may be used in connection with a high pressure injection system for applying a soil treatment (e.g., pesticide, insecticide, termiticide, fertilizer or micronutrient) beneath the surface of the ground, which is described below in detail. It is understood that the system disclosed herein can be used to apply any suitable soil treatment including pesticide, insecticide, termiticide or soil amendment and can be used to inhibit or control various types of pests, pathogens or add to the nutritional value of the soil. For example, it may be desirable to inhibit and/or control termites, ants, cockroaches, beetles, earwigs, silverfish, crickets, spiders, centipedes, millipedes, scorpions, pillbugs, sowbugs, flies, mosquitoes, gnats, moths, wasps, hornets, bees, and the like. As used herein, the term “pesticide” refers to any substance or mixture for preventing, destroying, repelling, or mitigating any pest including insects, animals (e.g., mice, rats), plants (e.g., weeds), fungi, microorganisms (e.g., bacteria and viruses), pseudocoelomates (e.g., nematodes) and prions. The term “insecticide”, which is a type of pesticide, is used herein to mean any substance or mixture for preventing, destroying, repelling, or mitigating insects. The term “termiticide”, which is a type of insecticide, is used herein to mean any substance or mixture for preventing, destroying, repelling, or mitigating termites.

Although the methods and systems described herein relate to the application of termiticides beneath the surface of the ground, the methods and systems could also be used to apply pesticides, insecticides, or other soil treatments. The use of termiticides as described herein is not intended to be limiting in any way. Rather, it is for exemplary purposes. The methods and systems described herein may be used, therefore, to apply any type of soil treatment beneath the ground (e.g., pesticides, fertilizers, other soil conditioning materials and insect treatments including insecticides placed around the perimeter of a structure), and is in no way limited to only termiticides.

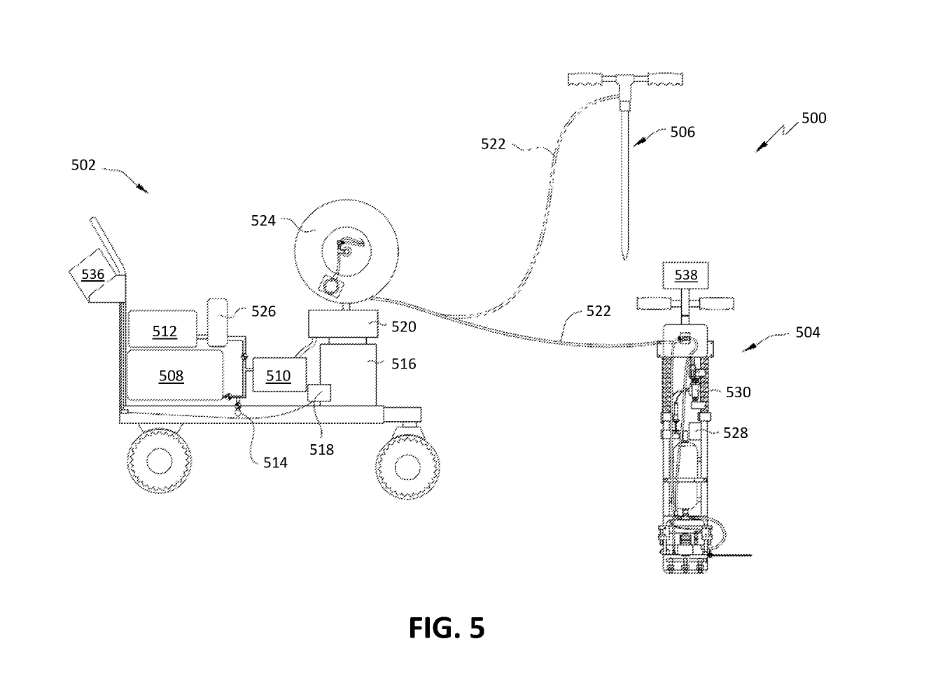

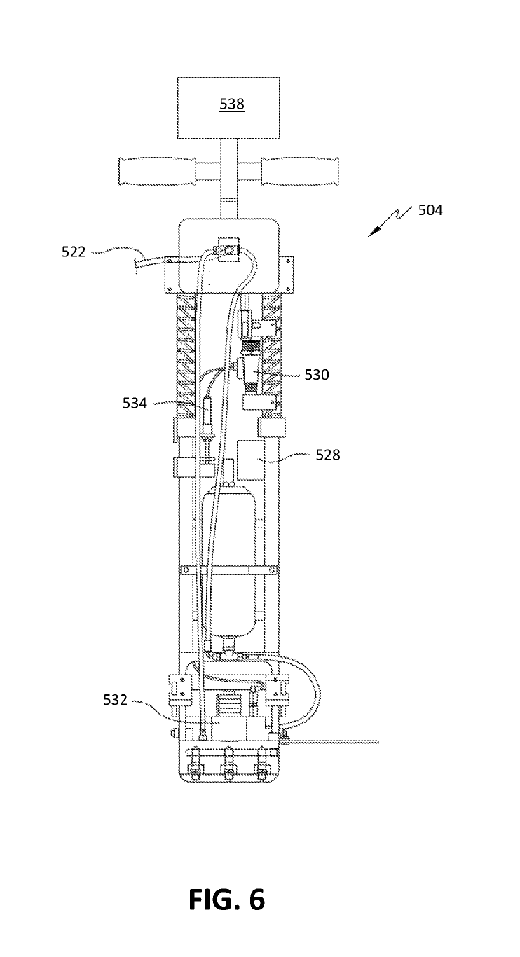

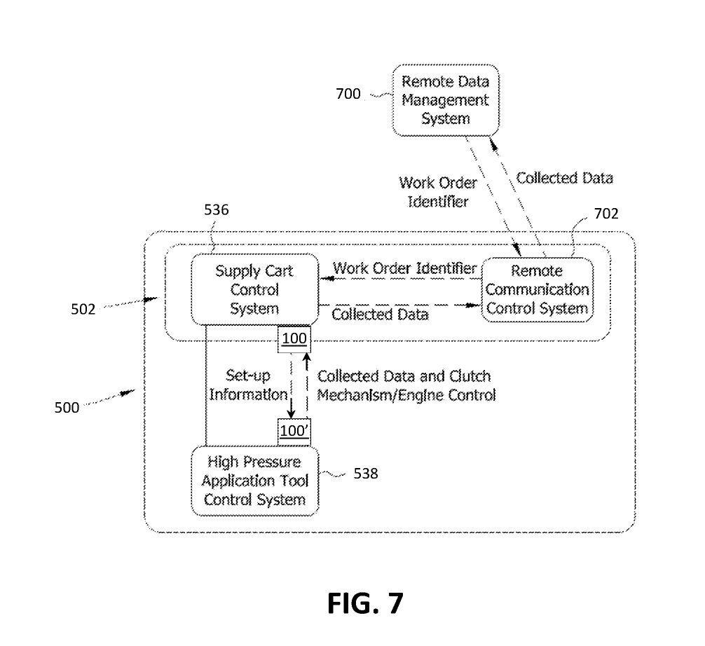

FIGS. 5-7 illustrate an embodiment of an apparatus 500 for applying a soil treatment beneath the surface of the ground. The apparatus 500 generally comprises a base unit in the form of a supply cart 502, a handheld portable high pressure application tool 504 and a handheld portable low pressure application tool 506. One or more components of the supply cart 502 are communicatively coupled together using a first CAN bus (not shown). One or more components on the high pressure application tool 504 are communicatively coupled together using a second CAN bus (not shown). Two BCB devices 100 and 100′ (shown in FIG. 7) are used to wirelessly bridge the first CAN bus and the second CAN bus, and to allow remote Bluetooth enabled devices to communicate with the apparatus 500. FIG. 6 is a front view schematic illustration of the high pressure application tool 504. The supply cart 502 functions as a fluid delivery device and includes a water reservoir 508, pressure pump 510, second termiticide concentrate reservoir 512, water inlet 514, gasoline engine 516 with generator 518 for operating the pressure pump 510, and clutch mechanism 520. A radiator is not needed because the clutch mechanism 520 is sufficient to inhibit over heating due to pressurized water driven by the high pressure pump 510.

The high pressure application tool 504 is in fluid communication with the supply cart 502 via a conduit 522 (e.g., a hose supported by a hose reel 524) that permits fluid (e.g., water and/or a termiticide solution from the mixing device 526) to flow from the cart 502 to the high pressure application tool. The conduit 522 does not include a wired electrical connection to the high pressure application tool 504. Rather, the high pressure application tool 504 is battery powered by a suitable rechargeable battery 528. In one embodiment, the battery 528 is removable from the application tool 504 for recharging. In other embodiments, the battery 528 may be charged while remaining on the application tool 504. A suitable power switch (not shown) is provided on the high pressure application tool 504 in electrical communication with the battery 528 for use in shutting down the battery for turning on and off the application tool. It is understood, however, that an electrical cable or other wired electrical connection may electrically connect the high pressure application tool 504 with the supply cart 502 and remain within the scope of this disclosure.

The handheld, portable high pressure application tool 504 is moveable (and thus positionable) relative to the supply cart 502 (i.e., relative to the base unit). The conduit 522 includes a quick connect (not shown) for releasable connection with the high pressure application tool 504 to permit selective connection and disconnection of the high pressure application tool from the supply cart 502. A pressure relief valve, not shown, is provided on the high pressure application tool 504 to bleed off pressure in the tool prior to disconnecting the conduit 522 from the high pressure application tool. It is understood that in other embodiments any other suitable high pressure application tool may be used without departing from the scope of this disclosure.

The high pressure application tool 504 of this embodiment uses a dosing device 530 in fluid communication with the termiticide concentrate reservoir 512 to deliver a predetermined amount (i.e., a dose or dosing volume) of concentrated termiticide (broadly referred to as an active ingredient) to the first mixing device 532 (shown in FIG. 6) each time the trigger switch 534 is actuated. In one suitable embodiment, the dosing device 530 is adjustable so that the predetermined amount of concentrated termiticide (i.e., the dosing volume) can be adjusted. In another suitable embodiment, the dosing device 530 is non-adjustable. That is, the amount of concentrated termiticide delivered to the mixing device 532 each time the trigger switch 534 is actuated cannot be changed without replacement of the dosing device. In this manner, the predetermined dosing volume is independent of the pressure of the carrier liquid (e.g., water) used for each injection of the high pressure application tool 504, and independent of how much water is used per injection. Rather, the dosing volume is based solely on the injection event itself.

The low pressure application tool 506 in accordance with one embodiment comprises a conventional rodding tool. The rodding tool 506 is configured for fluid communication with the supply cart 502 via the conduit 522 in the low pressure mode of the apparatus 500. More suitably, the rodding tool 506 is configured for releasable connection with the conduit 522, such as using the quick connect (not shown) on the conduit. In this manner, the rodding tool 506 is readily and selectively interchangeable with the high pressure application tool 504 upon switching operation of the apparatus 500 between the high pressure mode and the low pressure mode. It also understood that the low pressure application tool 506 may be other than a rodding tool, such as a wand, a trenching device, sprayer or any other portable, handheld tool that can receive a low pressure flow of soil treatment and direct the soil treatment through an outlet into the soil—such as by pushing the tool down into the soil or by pre-digging holes or trenches into the ground and then lowering the tool therein before dispensing the soil treatment—or dispensing the soil treatment onto the soil surface.

In the exemplary embodiment, only one of the low pressure application tool 506 and the high pressure application tool 504 is connected to the conduit 522 at a time. Thus, the low pressure application tool is inoperable when the high pressure application tool is operating and the high pressure application tool is inoperable when the low pressure application tool is operating. Additionally, the apparatus 500 is inoperable in the high pressure mode when the low pressure application tool 506 is connected to the supply cart 502.

In this embodiment, the second mixing device 526 on the supply cart 502 comprises a suitable peristaltic pump operable to deliver active ingredient (e.g., concentrated termiticide in the illustrated embodiment) from the concentrate reservoir 512 for admixture with the carrier liquid (e.g., water) from the pressure pump 510 at low pressure before delivery to the low pressure application tool 506. The construction and operation of a peristaltic pump is conventionally known and thus not described in further detail herein except to the extent necessary to make the present disclosure. The peristaltic pump 526 is suitably operable to deliver the concentrated termiticide from the reservoir 512 based on a predetermined mixture ratio as a function of the rate of delivery of concentrated termiticide to a flow rate of carrier liquid (e.g., water) delivered by the pressure pump 510.

In a particularly suitable embodiment, the rate at which the peristaltic pump 526 operates (e.g., revolutions per minute) may be adjustable to accommodate different carrier liquid flow rates delivered from the pressure pump 510. This allows the mixture ratio of the active ingredient to carrier liquid to remain at a desired or predetermined mixture ratio irrespective of whether the flow rate changes during operation, or is different from one treatment to the next. More suitably, the operating rate of the pump 526 may be automatically adjustable, such as by a suitable controller (not shown) that automatically adjusts the operating rate of the pump as a function of a signal indicative of the carrier liquid flow rate during treatment in the low pressure mode of the apparatus 500. The carrier liquid flow rate is suitably monitored by a flow meter (not shown) located upstream of where the carrier liquid admixes with the active ingredient. A flow cell (also not shown) disposed on the line downstream of the pump 526 but upstream of the location at which active ingredient admixes with the carrier liquid monitors the presence of active ingredient flowing there through to provide confirmation that the active ingredient is still flowing during operation.

In operation according to one embodiment of a method for applying soil treatment to soil, and in particular applying the soil treatment beneath the surface of the ground, the apparatus 500 may be operated in the high pressure mode in accordance with a first treatment along a first area of a work site to be treated, and then operated in the low pressure mode in accordance with a second treatment along a second area of the work site, different from the first area of the work site. For example, where a work site is a residential property in which the treatment is to be applied about the perimeter of a home, a first area of the perimeter (either a continuous segment of the perimeter, or multiple discrete segments of the perimeter) may be composed of a soil that is suitable for using the high pressure mode of the apparatus 500, while another area (a second area) of the perimeter (continuous, or multiple discrete segments) may not be suitable for using the high pressure mode of the apparatus and thus the low pressure mode of the apparatus must be used to apply the soil treatment. It is understood, however, that a single treatment may comprise operation of the apparatus 500 only in the high pressure mode, or only in the low pressure mode, and remain within the scope of this disclosure.

It is also contemplated that in other embodiments the second work area in which the low pressure mode is used may overlap all or part of the first work area in which the high pressure mode is used. For example, where soil treatment into the soil to a depth of the footer or basement (e.g., beyond the 12-16 inch depth to which the soil treatment may be injected in the high pressure mode of the apparatus 500), the high pressure mode application is applied to the first area to cover the upper 12-16 inches of soil, and the low pressure mode application is applied to the second area overlapping the first area. In particular, such a low pressure mode application may include inserting an application tool, such as the rodding tool 506, down into the soil to deliver soil treatment below the injected depth (e.g., 12-16 inches) down to the footer or basement. The application tool may be intermittently inserted into the ground at spaced apart locations along the entire perimeter of the footer or basement.

With reference again to FIG. 5, in this embodiment a dual control system, comprising a first (e.g., base unit, or supply cart) control system 536 disposed on the supply cart 502 and a second (e.g., application tool) control system 538 disposed on the high pressure application tool 504, is employed to control the overall operation of the apparatus 500 and to provide the operator with some control over the operation while using the high pressure application tool remote from the supply cart. The supply cart control system 536 suitably comprises at least a controller, such as a microcontroller, and a display unit, with user interface, used by the operator to select various operating aspects of the apparatus. The application tool control system 538 also includes a controller, such as a microcontroller, and a display unit with associated user interface. In the illustrated embodiment, the supply cart control system 536 and the application tool control system 538 communicate with each other via wireless communication—and in particular by a pair of transceivers, each being disposed on a respective one of the supply cart 502 and the high pressure application tool 504. It is understood, however, that in other embodiments the control systems 536, 538 may communicate by wired connection, such as by a cable or other suitable connection extending from the supply cart 502 to the high pressure application tool 504.

With reference to FIG. 7, the apparatus 500, and more particularly the supply cart control system 536 and the application tool control system 538, in accordance with one embodiment, are suitably configured to operate along with, e.g., via wireless communication with, a remote data management system 700 such as a website, a remote computer or other suitable system capable of transmitting and receiving data or other information to and from the supply cart control system 536 and/or the application tool control system 538. For example, in the illustrated embodiment of FIG. 7 the supply cart 502 further comprises a remote communication control system 702 (shown schematically in FIG. 28) carried on board the supply cart, and more suitably within the housing or control box that houses the supply cart control system 536, and including at least a second transceiver and a related controller configured for communication with the remote data management system 700. The remote communication control system 702 is also configured for communication with the supply cart control system 536, suitably by wired connection although it may alternatively be by wireless connection, to allow the transfer of data therebetween.

As illustrated in FIG. 7, the supply cart 502 includes the BCB device 100 coupled to its control system 536, and the high pressure application tool 504 includes the BCB device 100′ coupled to its control system 538. The BCB devices 100 and 100′ are configured to operate in a configuration similar to the configuration 400 shown in FIG. 4, with the BCB device 100 as server and the BCB device 100′ as a client. The BCB devices 100 and 100′ bridge the CAN buses of the supply cart 502 and the tool 504 to permit wireless communication between the supply cart 502 and the high pressure application tool 504. The BCB device 100, as the server, can also establish Bluetooth communication with one or more remote devices, such as the remote device 202 (shown in FIG. 2), the remote device 402 (shown in FIG. 4), and the remote data management system 700. In other suitable embodiments, the BCB device 100′ takes the role of server and can establish Bluetooth communication with the one or more remote devices.

In suitable embodiments, the BCB device 100 also forms part of the remote communication system. In such embodiments, the BCB device 100 is used to establish a Bluetooth connection between the supply cart control system 536 and a remote Bluetooth enabled device. In some embodiments the remote Bluetooth enabled device is one or more computing devices that make up the remote data management system 700. Alternatively, the remote device is a cellular phone, tablet, computer, or other device that is in, or has been in, communication with the remote data management system.

In a more particular example, the remote data management system 700 may be located at, or accessible by (e.g., in the form of an accessible website), a pest management company having multiple field operators that transport a respective apparatus 500 to customer locations to apply a soil treatment at the customer locations. The pest management company can download data to each apparatus using the communication between the remote data management system 700 and the remote communication control system 702 on the supply cart 502, and can receive data collected during operation of the apparatus 500 at each of the customer locations. For example, the pest management company can transmit data to the remote communication control system 702, such as a work order identifier and physical address of the different work sites at which the treatment is to occur. The remote communication control system 702 then communicates the information to the supply cart control system 536 for use in performing the desired treatment at the customer work site. Upon completion of the treatment, data collected during the treatment process is communicated by the supply cart control system 536 to the remote communication control system 702, where the data is then transmitted to the remote data management system 700.

Of course, it is understood that in other embodiments the apparatus 500 may operate independent of or entirely without the remote data management system 700 and remain within the scope of this disclosure. It is also contemplated that the remote communication control system 702 may be omitted, such that the remote data management system 700 communicates (e.g., by wireless communication) directly with the apparatus 500, such as the supply cart control system 536 and/or the application tool control system 538.

It is also contemplated that in some embodiments the remote data management system 700 may be configured to receive data collected by the supply cart control system 536 and/or the application tool control system 538 other by wireless communication. For example, the remote data management system 700 may be hardwire connected to the injection apparatus control system 536 and/or application tool control system 538 (or, in other embodiments, to the remote communication control system 702) for transferring the collected data to the data management system, or it may be configured for releasable hardwire connection, such as by a USB cable or other data transfer cable to the supply cart control system 536, application tool control system 538 and/or remote communications control system 702 for transferring the collected data to the data management system, or it may be configured for receiving a transportable data storage media, such as a USB drive, compact disc or other transportable data storage media containing the collected data. Other suitable treatment devices and systems with which the BCB 100 may be used are described in U.S. patent application Ser. No. 14/152,001, published as US Patent Application Publication No. 2014/0123884, the entire disclosure of which is incorporated herein by reference in its entirety.

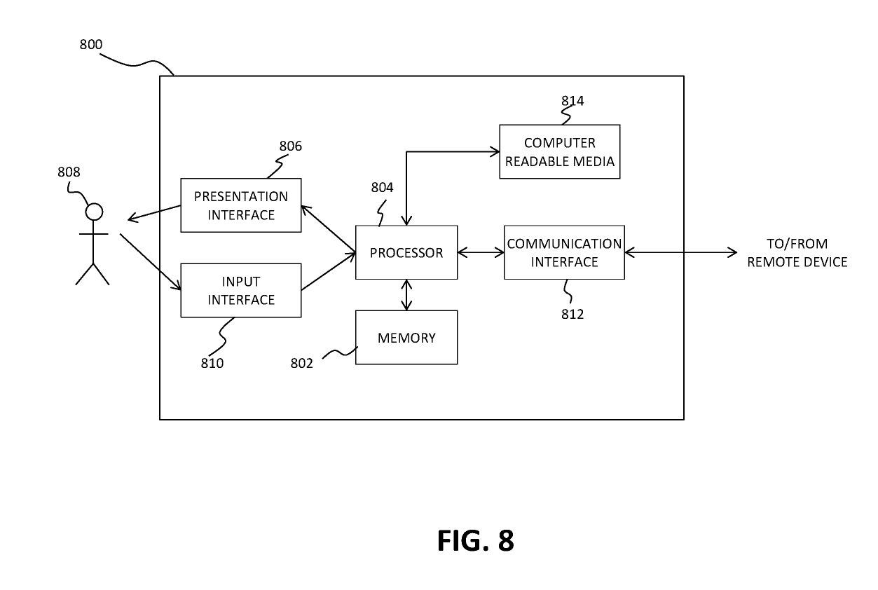

The various devices and systems described herein may include computing devices. For example, the BCB device 100 includes the BCB controller 108, which is or forms part of a computing device in suitable embodiments. The supply cart control system 526 and the high pressure application tool control system 538 each also includes a computing device in suitable embodiments. FIG. 8 is a schematic diagram of an example computing device 800 for use in the BCB device, the supply cart 502, and the high pressure tool 504.

In the exemplary implementation, the computing device 800 includes a memory device 802 and a processor 804 that is coupled to the memory 802 for executing programmed instructions. The processor 804 may include one or more processing units (e.g., in a multi-core configuration). The computing device 800 is programmable to perform one or more operations described herein by programming the memory device 802 and/or the processor 804. For example, the processor 804 may be programmed by encoding an operation as one or more executable instructions and providing the executable instructions in the memory device 802.

The processor 804 may include, but is not limited to, a general purpose central processing unit (CPU), a microcontroller, a reduced instruction set computer (RISC) processor, an application specific integrated circuit (ASIC), a programmable logic circuit (PLC), and/or any other circuit or processor capable of executing the functions described herein. The methods described herein may be encoded as executable instructions embodied in a computer-readable medium including, without limitation, a storage device and/or a memory device. Such instructions, when executed by the processor 804, cause the processor 804 to perform at least a portion of the methods described herein. The above examples are exemplary only, and thus are not intended to limit in any way the definition and/or meaning of the term processor.

The memory device 802, as described herein, is one or more devices that enable information such as executable instructions and/or other data to be stored and retrieved. The memory device 802 may include one or more computer-readable media, such as, without limitation, dynamic random access memory (DRAM), static random access memory (SRAM), a solid state disk, and/or a hard disk. The memory device 802 may be configured to store, without limitation, maintenance event log, diagnostic entries, fault messages, and/or any other type of data suitable for use with the methods and systems described herein.

In the exemplary implementation, the computing device 800 includes a presentation interface 806 that is coupled to the processor 804. The presentation interface 806 outputs (e.g., display, print, and/or otherwise output) information such as, but not limited to, installation data, configuration data, test data, error messages, and/or any other type of data to a user 808. For example, the presentation interface 806 may include a display adapter (not shown in FIG. 8) that is coupled to a display device, such as a cathode ray tube (CRT), a liquid crystal display (LCD), a light-emitting diode (LED) display, an organic LED (OLED) display, and/or an “electronic ink” display. In some implementations, the presentation interface 806 includes more than one display device. In addition, or in the alternative, the presentation interface 806 may include a printer. In other suitable embodiments, computing device 800 does not include a presentation interface 806.

In the exemplary implementation, the computing device 800 includes an input interface 810 that receives input from the user 808. For example, the input interface 810 may be configured to receive selections, requests, credentials, and/or any other type of inputs from the user 808 suitable for use with the methods and systems described herein. In the exemplary implementation, the input interface 810 is coupled to the processor 804 and may include, for example, a keyboard, a card reader (e.g., a smartcard reader), a pointing device, a mouse, a stylus, a touch sensitive panel (e.g., a touch pad or a touch screen), a gyroscope, an accelerometer, a position detector, and/or an audio input interface. A single component, such as a touch screen, may function as both a display device of the presentation interface 806 and as the input interface 808. In other suitable embodiments, computing device 800 does not include an input interface 808.

In the exemplary implementation, the computing device 800 includes a communication interface 812 coupled to the memory 802 and/or the processor 804. The communication interface 812 is coupled in communication with a remote device, such as another the computing device 800, CAN bus, the CAN controller 104 (shown in FIG. 1), the Bluetooth module (shown in FIG. 1), etc. For example, the communication interface 812 may include, without limitation, a wired network adapter, a wireless network adapter, an input/output port, and/or a telecommunications adapter.

Instructions for operating systems and applications are located in a functional form on non-transitory the memory device 802 for execution by the processor 804 to perform one or more of the processes described herein. For example, in some embodiments, the bootloader 112 and the application 114 (both shown in FIG. 1) are stored in the memory 802. These instructions in the different implementations may be embodied on different physical or tangible computer-readable media, such as the memory 802 or another memory, such as a computer-readable media 814, which may include, without limitation, a flash drive, CD-ROM, thumb drive, floppy disk, etc. Computer-readable media 814 is selectively insertable and/or removable from the computing device 800 to permit access and/or execution by the processor 804. In one example, computer-readable media 814 includes an optical or magnetic disc that is inserted or placed into a CD/DVD drive or other device associated with the memory 802 and/or the processor 804. In other suitable embodiments, computer-readable media 118 may not be removable. In still other suitable embodiments, the computing device 800 does not include the computer-readable media 814.

Various other suitable embodiments in which the BCB 100 may be used are described below.

In one suitable embodiment, an apparatus for injecting a soil treatment into subsurface soil is described. The apparatus includes an injection apparatus operable to inject soil treatment under high pressure down into the soil. The apparatus also includes a base unit operable to deliver pressurized fluid to the injection apparatus. The injection apparatus is connected to the base unit by a conduit defining a fluid passageway therebetween. The injection apparatus is positionable remote from the base unit. The base unit includes a base unit control system for controlling operation of the base unit to deliver pressurized fluid to the injection apparatus. The injection apparatus includes an injection apparatus control system in communication with the base unit control system for controlling operation of the base unit from a position remote from the base unit.

In one suitable embodiment, the injection apparatus control system is operable to communicate with the base unit control system using the BCB device to one or more of pause delivery of pressurized fluid from the base unit to the injection apparatus, and shut down operation of the base unit.

In another suitable embodiment, the injection apparatus control system has a manual input device accessible to an operator of the injection apparatus such that the operator of the injection apparatus is able, through the BCB device, to control operation of the base unit from a position remote from the base unit.

In yet another suitable embodiment, the injection apparatus control system is in wireless communication with the base unit control system through the BCB device. Furthermore, in another embodiment, the injection apparatus is operable to inject soil treatment under high pressure down into the soil in the event that the wireless communication between the injection apparatus control system and the base unit control system is broken upon positioning of the injection apparatus remote from the base unit.

Moreover, in another suitable embodiment, the injection apparatus control system is configured to collect data indicative of the number of injections performed by the injection apparatus. Furthermore, in one embodiment, the injection control system is configured to store a predetermined dosing volume of active ingredient to be delivered by the injection apparatus upon each injection event. The injection control system is further configured to determine, after each injection, a total amount of active ingredient delivered as a function of the number of injections and the predetermined dosing volume.

In addition, in another embodiment, the injection apparatus control system is further configured to transmit the collected data to the base unit control system using the BCB device. The injection apparatus control system is further configured to at least temporarily store the collected data in the event that wireless communication between the injection apparatus control system and the base unit control system is broken upon positioning of the injection apparatus remote from the base unit, and to transmit the stored data to the base unit upon wireless communication using the BCB device being reestablished between the injection apparatus control system and the base unit control system.

In another suitable embodiment, the apparatus set forth above includes a remote data management system located remote from the injection apparatus and the base unit. The injection apparatus control system is in communication with the remote data management system to transmit the collected data to the remote data management system. In some embodiments, the injection apparatus control system is in communication with the remote data management system through the BCB device.

In another suitable embodiment, a soil treatment system for treating a work site having a geographical address is described. The soil treatment system includes an injection apparatus operable to inject pressurized soil treatment down into the soil. The system also includes a control system in communication with the injection apparatus through the BCB device for controlling operation of the injection apparatus. The control system is configured for receiving input data corresponding to the geographical address of the work site. The control system inhibits operation of the injection apparatus in the event that the control system does not receive data corresponding to the geographical address of the work site.

In another suitable embodiment, the data received by the control system includes a work order identifier associated with the geographical address of the work site. The control system inhibits operation of the injection apparatus if no work order identifier is received by the control system, or the work order identifier received by the control system does not correspond to the geographical address of the work site. Further, in another embodiment, the data received by the control system further includes the address of the work site.

In yet another suitable embodiment, the system described above includes a remote data management system in communication with the control system of the soil treatment system through the BCB device. The control system of the soil treatment system receives the data corresponding to the geographical address of the work site from the remote data management system.

In still another embodiment, the system described above further includes a base unit in fluid communication with the injection apparatus and operable to deliver pressurized fluid to the injection apparatus for operation of the injection apparatus to inject pressurized soil treatment down into the soil. The injection apparatus is positionable relative to the base unit. The control system is disposed on the base unit such that in the event that data corresponding to the geographical address of the work site is not received by the control system the base unit is inoperable to deliver pressurized fluid to the injection apparatus. In addition, in one embodiment, the control system is a base unit control system. The soil treatment system further includes an injection apparatus control system carried by the injection apparatus and configured for communication with the base unit control system. The injection apparatus control system is inoperable in the event that the base unit control system does not receive data corresponding to the geographical address of the work site.

In another suitable embodiment, the control system is further configured to transmit, using the BCB device, a signal to the remote data management system indicative of the treatment of the work site being completed.

In yet another suitable embodiment of the system set forth above, the control system is further configured to collect data associated with each injection delivered by the injection apparatus. In addition, in one embodiment, the collected data includes the number of injections delivered by the injection apparatus while treating the work site. In a further embodiment, the system is in combination with a remote data management system in communication with the control system of the soil treatment system using the BCB device. The control system of the soil treatment system is in communication with the remote data management system and configured to transmit the collected data to the remote data management system.

In another suitable embodiment, the control system is further configured to allow operation of the injection apparatus in a test mode in the absence of input data corresponding to the geographical address of the work site. The control system is configured to receive input data indicative of the test mode and to operate the injection apparatus in the test mode in response to the input data.

In one particularly suitable embodiment, an apparatus for applying soil treatment to soil at a work site is described. The apparatus is selectively operable in a high pressure mode in which the apparatus injects pressurized soil treatment down into the soil and a low pressure mode in which the apparatus applies soil treatment to the soil under a pressure substantially lower than the pressurized soil treatment of the high pressure mode. The apparatus has a control system for controlling operation of the apparatus in the high pressure mode and in the low pressure mode. The control system includes a user interface accessible to an operator of the apparatus for selecting the mode of operation of the apparatus. The control system inhibits operation of the apparatus in the low pressure mode upon selection by the operator of the high pressure mode, and inhibits operation of the apparatus in the high pressure mode upon selection by the operator of the low pressure mode.

In another suitable embodiment of the apparatus set forth above, the soil treatment includes an active ingredient and a carrier liquid. The control system is further configured to permit the operator to select, at the user interface, one or more of a mixture ratio of active ingredient to carrier liquid for operation of the apparatus in the low pressure mode, and an operating parameter associated with the mixture ratio of active ingredient to carrier liquid for the low pressure mode. In another embodiment, the operating parameter includes one of the type and name of the active ingredient.

Furthermore, in another suitable embodiment of the apparatus set forth above, in the high pressure mode of the apparatus, each injection by the apparatus lasts for a discrete injection time period. The control system is further configured to permit the operator to select, at the user interface, one or more of the injection time period to be used in the high pressure mode, and an operating parameter associated with the injection time period to be used in the high pressure mode. In addition, in another embodiment, the operating parameter includes the type of soil into which the soil treatment is to be injected in the high pressure mode. The type of soil includes a first type of soil for which the injection time period has a first injection time period, and a second type of soil for which the injection time period has a second injection time period different from the first injection time period.

In yet another embodiment of the apparatus set forth above, the control system includes a display unit accessible to the operator to provide visual indicia of the modes from which the operator may select. In addition, in one embodiment, the user interface includes one of at least one selection button adjacent the display unit and a touchscreen display on the display unit.

In still another embodiment, a control system for operating a soil treatment apparatus to treat soil at a work site is described. The apparatus is selectively operable in a high pressure mode in which the apparatus injects pressurized soil treatment down into the soil and a low pressure mode in which the apparatus applies soil treatment to the soil under a pressure substantially lower than the pressurized soil treatment of the high pressure mode. The control system includes a display unit and is operable to display at least one parameter selection screen on the display unit. The control system also includes a user interface associated with the display unit and accessible by an operator of the soil treatment apparatus. The control system is operable to display a first parameter selection screen on the display unit with at least one parameter selection option associated with an injection time period during which, for each injection in the high pressure mode of the apparatus, soil treatment is injected into the soil. The control system is also operable to receive input from the operator, via the user interface, indicative of the operator's selected option associated with the injection time period. The control system is further operable to display a second parameter selection screen on the display unit with at least one parameter selection option associated with a mixture ratio of active ingredient to carrier liquid to be dispensed by the apparatus in the low pressure mode of the apparatus. In addition, the control system is operable to receive input from the operator, via the user interface, indicative of the operator's selected option associated with the mixture ratio of active ingredient to carrier liquid to be dispensed by the apparatus in the low pressure mode of the apparatus.

In another suitable embodiment of the control system, the at least one parameter selection option associated with the injection time period includes a plurality of injection time periods. In another suitable embodiment, the at least one parameter selection option associated with the injection time period includes a plurality of soil types wherein each soil type has a different injection time period associated therewith such that input by the operator indicative of the selected soil type automatically selects a corresponding injection time period.

In another suitable embodiment, the at least one parameter selection option associated with a mixture ratio of active ingredient to carrier liquid includes a plurality of mixture ratios. Alternatively, the at least one parameter selection option associated with a mixture ratio of active ingredient to carrier liquid includes a plurality of products, each product associated with an active ingredient to be used along with the carrier liquid in forming the soil treatment.

In another suitable embodiment, the control system is further configured to display a plurality of mixture ratio options associated with a single product, and to receive input from the operator, via the user interface, indicative of the operator's selected mixture ratio associated with the single product.

In yet another suitable embodiment, the control system is further configured to display a mode selection screen on the display unit with at least a first mode selection option indicative of the high pressure mode of operation of the apparatus and a second mode selection option indicative of the low pressure mode of operation of the apparatus, and receive input from the operator, via the user interface, indicative of the operator's selected option associated with the mode of operation of the apparatus.

In still another embodiment, the control system is further configured to display an operating screen on the display unit in the high pressure mode of the apparatus with at least one selected parameter relating to the high pressure mode of the apparatus. The operating screen further displays a selection option for switching operation of the apparatus to the low pressure mode. The control system is also configured to display an operating screen on the display unit in the low pressure mode of the apparatus with at least one selected parameter relating to the low pressure mode of the apparatus. The operating screen further displays a selection option for switching operation of the apparatus to the high pressure mode. In addition, in another embodiment, the control system is configured to collect data associated with operation of the apparatus in both the high pressure mode and the low pressure mode, for the operating screen in the high pressure mode, and for the operating screen in the low pressure mode. The control system is further configured to display a selection option for changing the display to a data screen to display data collected by the control system during operation of the apparatus in the corresponding mode of the apparatus. Furthermore, in one embodiment, the control system is provided in combination with a remote data management system in communication with the control system. For the operating screen in the high pressure mode and for the operating screen in the low pressure mode, the control system is further configured to display a selection option for transmitting data collected by the control system during operation of the apparatus in the corresponding mode of the apparatus to the remote data management system.

In one suitable embodiment, a method of applying soil treatment at a work site is described. The soil treatment includes an active ingredient and a carrier liquid. The method includes positioning an injection apparatus so that at least one high pressure nozzle of the injection apparatus is adjacent to the soil at a first injection site of the work site to be treated. The method also includes triggering the injection apparatus to deliver a pressurized soil treatment to the at least one high pressure nozzle whereby the pressurized soil treatment is jetted from the high pressure nozzle down into soil subsurface at said first injection site. Furthermore, the method includes repositioning the injection apparatus so that at least one high pressure nozzle of the injection apparatus is adjacent to the soil at a second injection site of the work site to be treated, and triggering the injection apparatus to deliver a pressurized soil treatment to the at least one high pressure nozzle whereby the pressurized soil treatment is jetted from the high pressure nozzle down into soil subsurface at said second injection site. Each triggering of the injection apparatus includes operating the injection apparatus for an injection time period during which carrier liquid is delivered at high pressure to the at least one high pressure nozzle, and a predetermined dosing volume of active ingredient is delivered toward the at least one high pressure nozzle for admixture with the carrier liquid to form the soil treatment injected into the soil. Each triggering of the injection apparatus also includes operating a control system of the injection apparatus to track the number of injections performed by the injection apparatus, and further operating the control system to determine the amount of active ingredient applied to the soil as a function of the number of injections performed and the predetermined dosing volume of the active ingredient.

In another suitable embodiment of the method set forth above, the control system is configured to permit selective adjustment of the injection time period. The predetermined dosing volume is independent of the injection time period.

In one suitable embodiment, the method further includes determining the type of soil into which the soil treatment is to be injected, and setting the injection time period as a function of the determined soil type.

In yet another suitable embodiment of the method, the work site includes a first area over which the soil treatment is applied using the injection apparatus, and a second area over which the soil treatment is applied using a low pressure application tool. The method further includes, either before or after using the injection apparatus to treat the first area of the work site, positioning the low pressure application tool over the second area of the work site. The method also includes operating the low pressure application tool to apply soil treatment to the second area of the work site. The operating of the low pressure application tool includes delivering a carrier liquid from a source of carrier liquid toward an outlet of the low pressure application tool, and pumping active ingredient from a source of active ingredient toward the outlet of the low pressure application tool for admixture with the carrier liquid to form the soil treatment upstream of the outlet of the low pressure application tool. The soil treatment has a mixture ratio of active ingredient to carrier liquid upon exiting the outlet of the low pressure application tool. The method further includes operating the control system to track the volume of carrier liquid delivered from the source of carrier liquid toward the outlet of the low pressure application tool, and further operating the control system to determine the amount of active ingredient applied to the soil by the low pressure application tool as a function of the volume of carrier liquid delivered from the source of carrier liquid to the outlet of the low pressure application tool, and the mixture ratio of active ingredient to carrier liquid.

In addition, in one embodiment, the method further includes inputting the mixture ratio of active ingredient to carrier liquid to the control system prior to operating the low pressure application tool. The mixture ratio is at least in part a function of the active ingredient used to form the soil treatment. In another embodiment, the rate at which active ingredient is pumped from the source of active ingredient is adjustable in response to changes in the rate of flow of the carrier liquid delivered from the source of carrier liquid to the outlet of the high pressure application tool. In another embodiment, the second area is discrete from the first area, and in another suitable embodiment, the second area at least in part overlaps the first area.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A wireless controller area network (CAN) bus bridge comprising:
a CAN subsystem configured to be communicatively coupled to a CAN bus to receive a CAN message from the CAN bus;
a wireless communication module operable to wirelessly communicate according to two different versions of a wireless communication protocol;
a controller coupled to the CAN subsystem and the wireless communication module, the CAN subsystem configured to provide the received CAN message to the controller, the controller programmed to generate a binary message including the received CAN message and provide the generated binary message to the wireless communication module for transmission from the wireless CAN bus bridge using at least one of the two different versions of the wireless communication protocol.

2. The wireless CAN bus bridge of claim 1 wherein the wireless communication module comprises a Bluetooth module operable to wirelessly communicate according to two different versions of the Bluetooth communication protocol.

3. The wireless CAN bus bridge of claim 2 wherein the two versions of the Bluetooth communication protocol are Bluetooth v2.x and Bluetooth v4.x.

4. The wireless CAN bus bridge of claim 2 wherein the Bluetooth module is configured to use a serial port profile when using a first version of the Bluetooth protocol, and configured to use a low energy serial port service when using a second version of the Bluetooth protocol.

5. The wireless CAN bus bridge of claim 1 wherein the CAN subsystem comprises a CAN transceiver and a CAN controller, the CAN transceiver configured to interface between the CAN controller and a CAN bus.

6. The wireless CAN bus bridge of claim 1, further comprising a selectable CAN bus termination coupled to the controller, wherein the controller is further configured to selectively enable the selectable CAN bus termination to selectively provide a termination on a CAN bus to which the wireless CAN bus bridge is attached.

7. The wireless CAN bus bridge of claim 1 wherein the controller is configured to include a cyclic redundancy code (CRC) in the binary message including the received CAN message to allow for error checking of the generated binary message.

8. The wireless CAN bus bridge of claim 1 wherein the controller is configured to:
receive an incoming binary message including an incoming CAN message from the Bluetooth module;
extract the incoming CAN message from the incoming binary message; and
provide the extracted incoming CAN message to the CAN subsystem for output to a CAN bus.

9. The wireless CAN bus bridge of claim 1 in combination with a soil treatment apparatus, wherein the soil treatment apparatus includes a CAN bus and the CAN subsystem of the wireless CAN bus bridge is coupled to the soil treatment apparatus's CAN bus.

10. A Bluetooth to controller area network bridge (BCB) device comprising:
a controller area network (CAN) subsystem configured to communicate with a CAN bus when attached to the CAN bus;
a Bluetooth module operable to wirelessly communicate according to a first version of the Bluetooth communication protocol and a second version of the Bluetooth communication protocol, wherein the first version and the second version are different versions of the Bluetooth communication protocol; and
a controller coupled to the CAN subsystem and the Bluetooth module, the controller programmed to provide, through the Bluetooth module, wireless communication between the CAN bus and a first remote device using the first version of the Bluetooth communication protocol.

11. The BCB device of claim 10 wherein the first version of the Bluetooth communication protocol is Bluetooth v2.x, and the second version of the Bluetooth communication protocol is Bluetooth v4.x.

12. The BCB device of claim 10 wherein the Bluetooth module is configured to use a serial port profile when using the first version of the Bluetooth protocol, and configured to use a low energy serial port service when using a second version of the Bluetooth protocol.

13. The BCB device of claim 10 wherein the controller is configured to provide, through the Bluetooth module, wireless communication between the CAN bus and a second remote device using the second version of the Bluetooth communication protocol.

14. The BCB device of claim 13 wherein the controller is configured to provide wireless communication between the CAN bus and the first remote device using the first version of the Bluetooth communication protocol at a same time as it provides wireless communication between the CAN bus and the second remote device using the second version of the Bluetooth communication protocol.

15. The BCB device of claim 13 wherein the controller is further configured to provide, through the Bluetooth module, wireless communication between the CAN bus and the second remote device using the first version of the Bluetooth communication protocol.

16. The BCB device of claim 13 wherein the first device is a like BCB device coupled to another CAN bus, and the second device is a remote computing device.

17. The BCB device of claim 10 in combination with a soil treatment apparatus, wherein the soil treatment apparatus includes a CAN bus and the CAN subsystem of the wireless CAN bus bridge is connected to the soil treatment apparatus's CAN bus.

18. A method of communicating with a controller area network (CAN) bus using a bridge device, the method comprising:
receiving, by a CAN subsystem of the bridge device, a first CAN message from a first CAN bus;
receiving, by a controller of the bridge device, the first CAN message from the CAN subsystem;
generating, by the controller, a first binary message including the first CAN message; and
transmitting, by a Bluetooth module of the bridge device operable to communicate according to a first version of the Bluetooth communication protocol and a second version of the Bluetooth protocol, the first binary message to a first device using the first version of the Bluetooth communication protocol.

19. The method of claim 18, further comprising:
receiving, by the Bluetooth module, a second binary message from the first device, the second binary message including a second CAN message from a second CAN bus;
extracting, by the controller, the second CAN message from the second binary message; and
outputting, by the CAN subsystem, the second message to the first CAN bus.

20. The method of claim 18, further comprising:
receiving, by the Bluetooth module using the second version of the Bluetooth protocol, a third binary message from a second device, the third binary message including a command for the bridge device;
extracting, by the controller, the command from the third binary message; and
acting on the command from the third binary message.
